(19) United States
(12) Patent Application Publication
(10) Pub. No.: US 2008/0016730 A1
(43) Pub. Date: Jan. 24, 2008

(54) CLAMSHELL BADGE/NAMETAG HOLDER

(75) Inventors: Nicholas Topitzes, Madison, WI (US); Jayne Martinson, Middleton, WI (US); Melissa Anunson, Mt. Horeb, WI (US)

Correspondence Address: FOLEY & LARDNER LLP, 150 EAST GILMAN STREET, P.O. BOX 1497, MADISON, WI, 53701-1497, US

(73) Assignee: PC/Nametag, Inc.

(21) Appl. No.: 11/779,393

(22) Filed: Jul. 18, 2007

Related U.S. Application Data
(60) Provisional application No. 60/831,956, filed on Jul. 19, 2006.

(51) Int. Cl. G09F 3/20; A44C 3/00; B65D 1/00; B65D 43/16

(52) U.S. Cl. 40/1.5; 220/833; 224/600

(57) ABSTRACT

A holder is provided comprising a first flap, a second flap, and a hinge all integrally formed from a thermoplastic material. The first flap and the second flap are connected by the hinge. The first flap includes a raised portion including at least one side wall, and a first face. The second flap includes a recessed portion including at least one side wall, and a second face. The raised portion is adapted to engage the recessed portion such that the first flap and the second flap are connected in a friction fit between the at least one side wall of the raised portion and the at least one side wall of the recessed portion.

### CROSS-REFERENCE TO RELATED APPLICATIONS

This application claims priority from U.S. Provisional Application No. 60/831,956, filed Jul. 19, 2006, incorporated herein by reference in its entirety.

### FIELD

The subject of the disclosure relates generally to holders for badges and/or nametags. More particularly, the disclosure relates to holders for nametags and/or badges that can be reused and are easily attachable to the wearer.

### BACKGROUND

Nametags or badges for identification for both formal and informal gatherings have become ubiquitous on the social landscape. People regularly use nametags at all kinds of social functions from small personal gatherings to conventions and tradeshows with hundreds or even thousands of people. Typically information such as name and/or affiliation of the wearer is displayed on the nametag; however a wealth of information may be provided. Sometimes more detailed information may be encoded on magnetic media or through the use of bar-coding so that information can be readily exchanged between participants and vendors. Holders for nametags, known in the art, tend to be cumbersome, unsuitable for quick and efficient exchange of display media, and/or due to awkward design or sharp edges can cut or injure one's fingers when opening and closing the holders.

### SUMMARY

The present invention generally provides a badge and/or nametag holder. Badge and/or nametag holders disclosed herein are reusable, can be displayed by a variety of methods, are capable of a quick change of the media or indicia-containing material, and/or do not injure fingers during use or during the course of filling numerous holders.

In one aspect, a holder is provided comprising a first flap, a second flap, and a hinge all integrally formed from a thermoplastic material; wherein the first flap and the second flap are connected by the hinge, the first flap comprising a raised portion comprising at least one side wall, and a first face, the second flap comprising a recessed portion comprising at least one side wall, and a second face, such that the raised portion is adapted to engage the recessed portion of the second flap, such that when the raised portion engages the recessed portion, the first flap and the second flap are connected in a friction fit between the at least one side wall of the first flap and the at least side wall of the second flap. In some embodiments, the holder further comprises a recessed button in which a magnet or magnetic material fastener may be attached. Indicia-containing material(s) may be displayed in the holder by inserting the material into the holder between the first face and the second face, and engaging the raised portion and the recessed portion. Generally, the holders may be referred to as clamshell holders for the reason that they open and close in a clamshell-like fashion.

In another aspect, a holder is provided comprising, consisting essentially of, or consisting of: a first flap, a second flap, and a hinge all integrally formed from a thermoplastic material; wherein the first flap and the second flap are connected by the hinge, the first flap comprising, consisting essentially of, or consisting of: a surface and a ridge extending upwardly from the surface, the ridge comprising at least one outer side wall, at least one inner side wall, and an apex, the second flap comprising, consisting essentially of, or consisting of a surface and a trough extending downwardly from the surface, the trough comprising, consisting essentially of, or consisting of at least one outer side wall, at least one inner side wall, and a nadir, the ridge adapted to engage the trough, such that when the ridge engages the trough, the first flap and the second flap are connected in a friction fit between the at least one outer side wall of the ridge and the at least one outer side wall of the trough, or between the at least one inner side wall of the ridge and the at least one inner side wall of the trough, or between both the at least one outer side wall of the ridge and the at least one outer side wall of the trough, and the at least one inner side wall of the ridge and the at least one inner side wall of the trough. In some embodiments, the holder further comprises a recessed button in which a magnet or magnetic material fastener may be attached. Indicia-containing material(s) may be displayed in the holder by inserting the material into the holder between the surface of the first flap and the surface of the second flap, and engaging the ridge and the trough.

Holders as described herein may be environmentally friendly as the holders may be produced from factory re-cycled materials and the holders themselves may be reused multiple times.

### BRIEF DESCRIPTION OF THE DRAWINGS

FIG. 1 is a perspective view of a holder in an open configuration, according to one embodiment.

FIG. 2 is a cross-sectional view of a holder an open configuration, according to one embodiment.

FIG. 3 is a perspective view of a holder with a recessed button in an open configuration, according to one embodiment.

FIG. 4 is a cross-sectional view of a holder with a recessed button in an open configuration, according to one embodiment.

FIG. 5 is a perspective view of a holder with a recessed button, and locking edge in an open configuration, according to one embodiment.

FIG. 6 is a perspective view of a holder with a ridge and a trough in an open configuration, according to one embodiment.

FIG. 7 is a perspective view of a holder with a ridge and a trough in a clamshell configuration, according to one embodiment.

FIG. 8 is a side view of a holder with a ridge and a trough in an open configuration, according to one embodiment.

FIG. 9 is a cross-sectional view of a holder with a ridge and a trough in an open configuration, according to one embodiment.

FIG. 10 is a frontal view of a holder in a closed configuration, according to one embodiment.

FIG. 11 is a top view of a holder with a recessed button in an open configuration, according to one embodiment.

FIG. 12 is a side view of a holder with a recessed button in an open configuration, according to one embodiment.

FIG. 13 is a perspective view of a holder with a recessed button, a magnet, and locking edge in a clamshell configuration, according to one embodiment.

FIG. 14 is a perspective view of a holder in an open configuration, according to one embodiment.

FIG. 15 is a perspective view of a holder in an open configuration with a raised surface on an external face of a flap, according to one embodiment.

### DETAILED DESCRIPTION

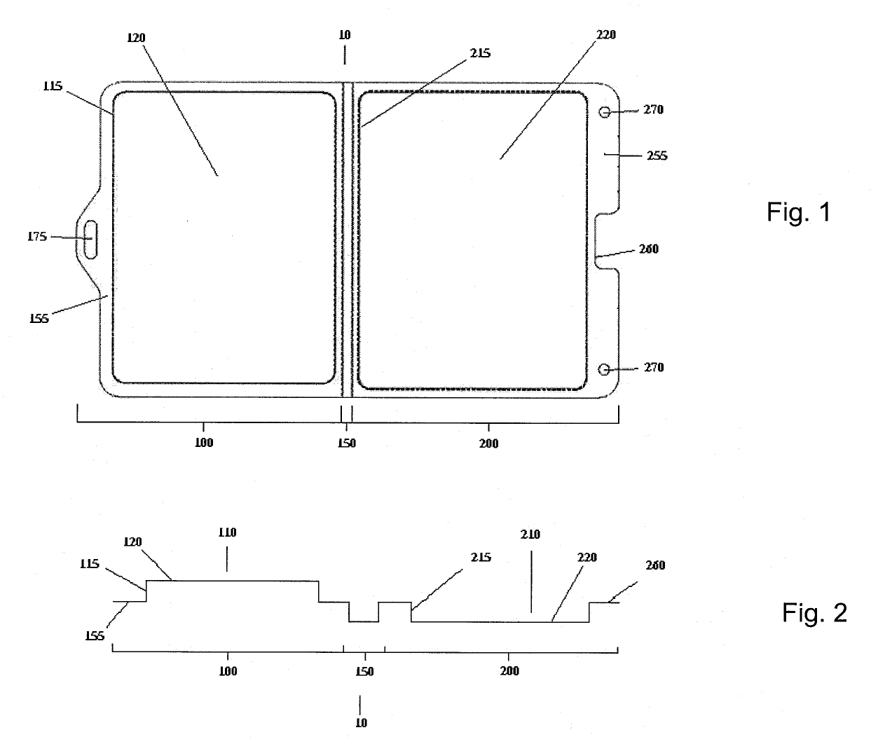

Referring to FIGS. 1 and 2, a holder 10 is provided comprising a first flap 100, a second flap 200, and a hinge 150, all integrally formed of a thermoplastic material, wherein the first flap 100 and the second flap 200 are connected by the hinge 150. In such embodiments, the first flap 100 comprises a raised portion 110, comprising at least one side wall 115, and a first face 120. In other such embodiments, the second flap 200 comprises a recessed portion 210, comprising at least one side wall 215, and a second face 220. In such embodiments, the raised portion 110 is adapted to engage the recessed portion 210, such that when the raised portion 110 engages the recessed portion 210, the first flap 100 and the second flap 200 are connected in a friction fit between the side wall 115 of the raised portion 110 and the side wall 215 of the recessed portion 210. As used herein, a closed configuration refers to a position of the holder 10 formed when the raised portion 110 engages the recessed portion 210.

In some embodiments, the holder 10 further comprises an indicia containing material capable of being secured in the holder 10 between the first face 120 and the second face 220, when the holder 10 is in a closed configuration. In some embodiments, the holder 10 is a nametag and/or badge holder and the indicia containing material is a nametag and/or badge.

In another aspect, the holder 10 further comprises a fastener attached to the holder 10. Typically, the fastener may be used to attach the holder to an article of clothing, so that a person may wear the holder 10 as a nametag and/or badge holder at work, conference, social gathering, or other function where people wear nametags. The fastener may also be used to attach to a neckstrap, cord, lanyard, or the like. Fasteners useful with the present holder 10 include, but are not limited to clips, pins, or rings. In some embodiments, the fastener is a retractable fastener. In some embodiments, the fastener further comprises a pressure sensitive adhesive for attachment of the fastener to the holder 10. In other embodiments, the holder 10 may further comprise an attachment loop. Such attachment loops may be integrated into the holder 10 such that a suitable fastener may be attached directly to the holder 10 without the need for an adhesive. In some such embodiments, an attachment loop 175 is formed in edge 155. In other embodiments, attachment loops may include integrally formed loops on a reverse face of the holder 10, the reverse face being a face that is parallel to and opposes the second face. Fasteners suitable for use with the holder 10 may also include, fasteners that may be attached to an article of clothing by a first end of the fastener and attached to the holder 10 by an end distal to the first end.

In some embodiments, the second flap 200 further comprises an edge 255 having at least one hole 270. Holes 270 may be used to attach a neckstrap, cord, lanyard, or the like to the holder. In some embodiments, there is more than one hole 270 for attachment of a neckstrap or lanyard device. In some embodiments, the holder further comprises a neckstrap. Edge 255 may also include an indented portion 260 that may prevent occlusion of attachment loop 175 when the holder 10 is in a closed configuration.

In other embodiments, the holder further comprises a pressure sensitive adhesive attached to the holder for adhesion of the holder directly to a substrate such as clothing, fabrics, display panels, and the like.

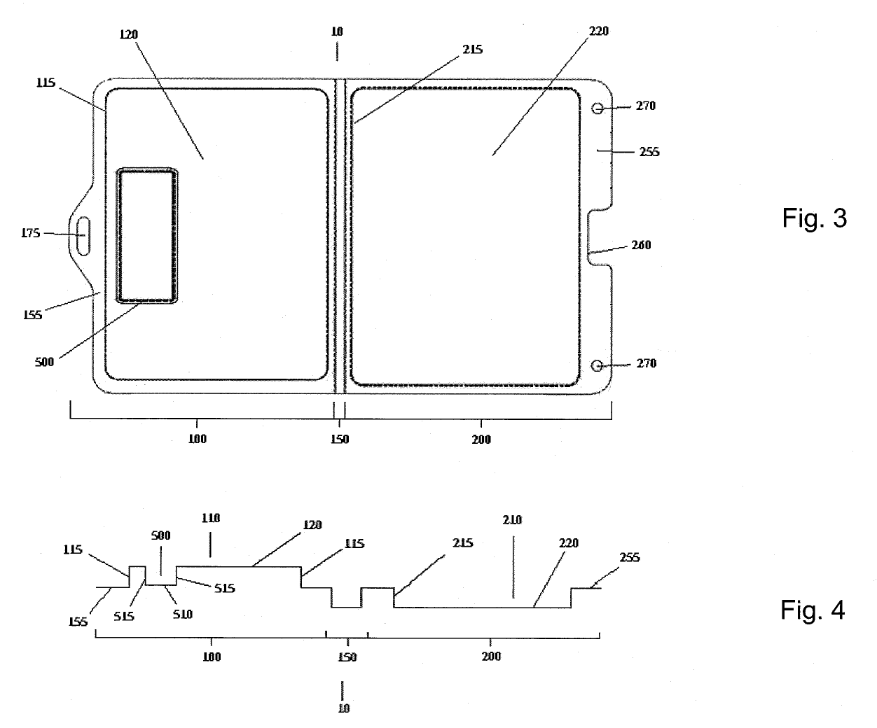

Referring to FIGS. 3-5, in another aspect, the holder 10 further comprises a recessed button 500. The recessed button comprises at least one side wall 515, and a floor 510. In some embodiments, the recessed button 500 holds a magnet or a magnetic material. In such embodiments, the magnet or magnetic material is used to magnetically fasten the holder to an article of clothing, neckstrap, lanyard, display panel, or other item. In such embodiments related to an article of clothing, the magnet or magnetic material in the recessed button 500 is attracted to a magnetic material, or magnet, respectively, that is placed on a side of the clothing opposite to where the holder 10 is displayed, thus forming a magnetic fastener. As used herein the term magnet is used for materials that display a permanent magnetism, while magnetic refers to materials that do not display a permanent magnetism, but rather are attracted to a magnet. In such embodiments relating to a neckstrap or lanyard, the neckstrap or lanyard has a magnetic material, or magnet, attached to the neckstrap or lanyard for attaching the holder 10. In such embodiments relating to a display panel, the display is constructed of a magnetic material, or has a magnetic metal attached, to which the magnet, or magnetic material in the recessed button may be attracted. As alluded to above, in some embodiments, a magnet is attached to the recessed button 500 and the magnetic material is external to the holder 10, while in other embodiments, a magnetic material is held in the recessed button 500 and the magnet is external to the holder 10. In some embodiments, the magnet or magnetic material is adhered to the recessed button 500 by an adhesive.

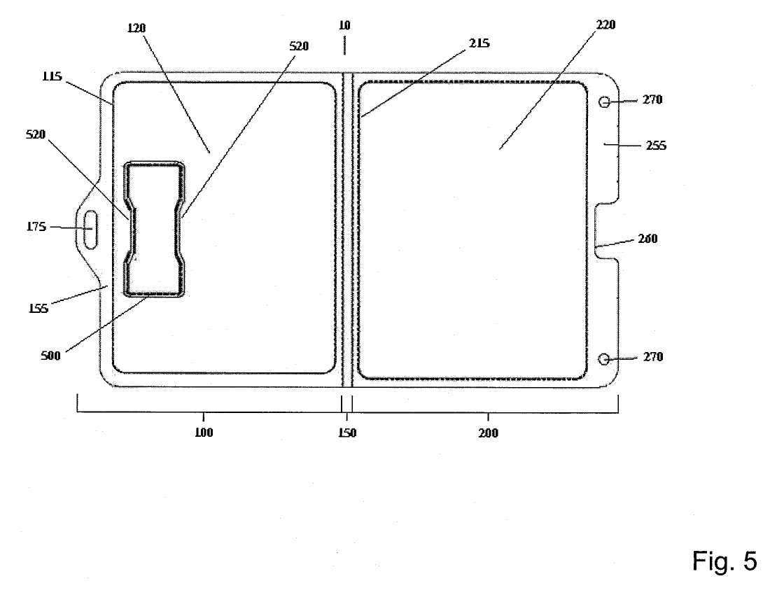

Referring specifically to FIG. 5, in some embodiments, the magnet, or magnetic material is held in the recessed button 500 by at least one locking edge 520, that extends over the recessed button 500 from the face 120. When the magnet, or magnetic material is inserted in the recessed button 500, the at least one locking edge 520 overlaps the magnet, or magnetic material to hold it in place in the recessed button 500. In some such embodiments, two or more locking edges 520 are provided. The locking edge 520 allows for quick insertion of the magnet, or magnetic material, into the recessed button 500, and for easy removal. The locking edge 520 also eliminates the need for separate adhesives for attaching the magnet or magnetic material to the holder 10, although the magnet, or magnetic material may be adhered to the recessed button 500 of the holder 10 by an adhesive.

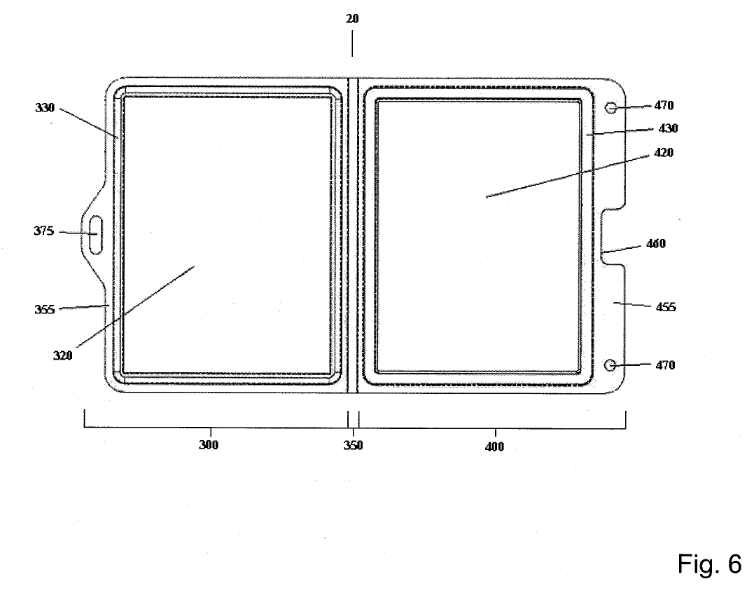

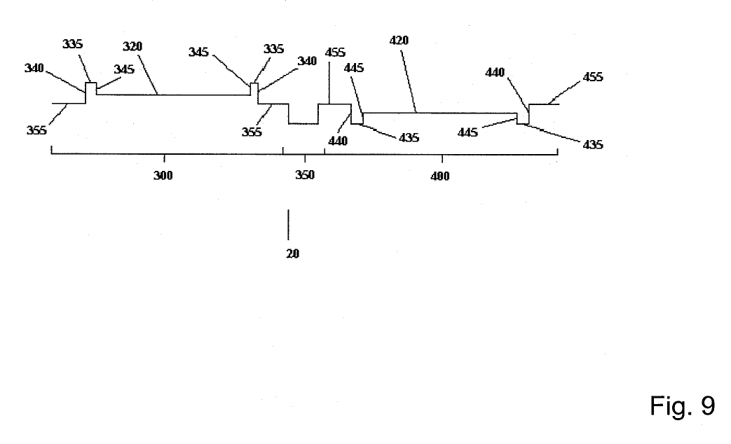

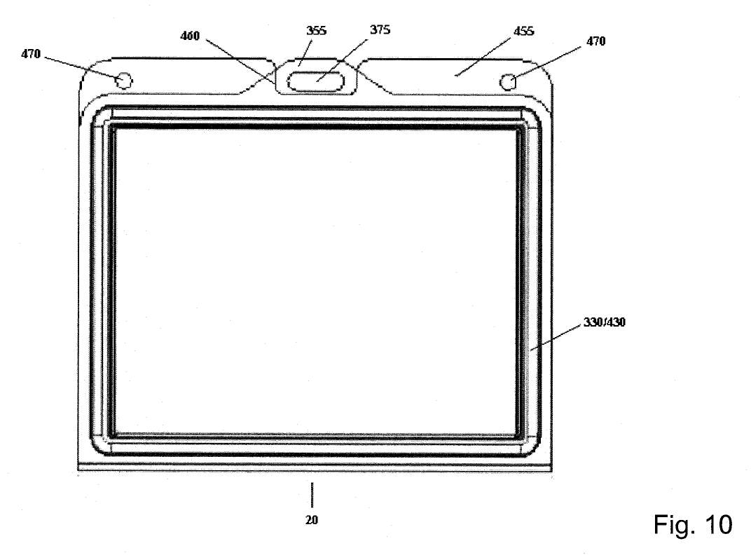

Referring now to FIGS. 6-10, in one aspect, a holder 20 comprises a first flap 300, a second flap 400 and a hinge 350, all integrally formed from a thermoplastic material, where the first flap 300 and the second flap 400 are connected by the hinge 350. In some embodiments, the first flap 300 comprises a surface 320 and a ridge 330 extending upwardly from the surface 320, the ridge 300 comprising at least one outer side wall 340, at least one inner side wall 345, and an apex 335. In other embodiments, the second flap 400 comprises a surface 420 and a trough 430 extending downwardly from the surface 420, the trough 430 comprising at least one outer side wall 440, at least one inner side wall 445, and a nadir 435. In some such embodiments, the ridge 330 is adapted to engage the trough 430, such that when the ridge 330 engages the trough 430, the first flap 300 and the second flap 400 are connected in a friction fit between the at least one outer side wall 340 of the ridge 330 and the at least one outer side wall 440 of the trough 430, or between the at least one inner side wall 345 of the ridge 330 and the at least one inner side wall 445 of the trough 430, or between the at least one outer side wall 340 of the ridge 330 and the at least one outer side wall 440 of the trough 430 and the at least one inner side wall 345 of the ridge 330 and the at least one inner side wall 445 of the trough 430. In some embodiments, the ridge 330 is continuous, forming a frame around the perimeter of the surface 320 of the first flap 300 and the trough 430 is continuous around the perimeter of the surface 420 of the second flap 400. Alternatively, the holder 20 may have a ridge associated with a second flap and a trough associated with a first flap. In some embodiments, the holder 20 is as embodied in FIGS. 6-10. While other depressions or recessions may be included in holder 20, vide infra, in some embodiments, holder 20 does not include any additional depressions or recessions in the first flap 300 or in the second flap 400, other than as shown in FIGS. 6-10. Such variations will be readily apparent to those of skill in the art.

In other embodiments, the holder comprises two or more ridges on a first flap and two or more troughs on a second flap, such that the two or more ridges on the first flap and the two or more troughs on the second flap are placed in complementary positions. In the context of this disclosure, the term complimentary refers to a ridge on one flap having a corresponding trough on the other flap such that the ridges and troughs are aligned to interlock when the holder 20 is folded into a closed configuration.

In some embodiments, the holder 20 further comprises an indicia containing material capable of being secured in the holder 20 between the surface 320 of the first flap 300 and the surface 420 of the second flap 400, when the holder 20 is in a closed configuration. In some embodiments, the holder 20 is a nametag and/or badge holder and the indicia containing material is a nametag and/or badge.

In some embodiments, the holders described are reuseable. Thus, the holders may be discarded after each use, or they may be collected and reused over and over again with new indicia-containing materials or other display items. In other embodiments, the holders described may contain recycled materials.

In another aspect, the holder 20 further comprises a fastener attached to the holder 20. Typically, the fastener may be used to attach the holder to an article of clothing, so that a person may wear the holder 20 as a nametag and/or badge holder at work, conference, social gathering, or other function where people wear nametags. The fastener may also be used to attach to a neckstrap, cord, lanyard, or the like. Fasteners useful with the present holder 20 include, but are not limited to clips, pins, or rings. In some embodiments, the fastener is a retractable fastener. In some embodiments, the fastener further comprises a pressure sensitive adhesive for attachment of the fastener to the holder 20. In other embodiments, the holder 20 may further comprise an attachment loop. Such attachment loops may be integrated into the holder 20 such that a suitable fastener may be attached directly to the holder 20 without the need for an adhesive. In some such embodiments, an attachment loop 375 is formed in edge 355. In other embodiments, attachment loops may include integrally formed loops on a reverse surface of the holder 20, the reverse surface being a surface that is parallel to and opposes the either the surface 320 of the first flap 300, or the surface 420 of the second flap 400. Fasteners suitable for use with the holder 20 may also include, fasteners that may be attached to an article of clothing by a first end of the fastener and attached to the holder 20 by an end distal to the first end.

In some embodiments, the first flap 300 comprises an edge 355 extending outward from the outer side wall 340 of the ridge 330, and the second flap 400 comprises an edge 455 extending outward from the outer side wall 440 of the trough 430. In some embodiments, the edge 455 comprises at least one hole 470. Holes 470 may be used for attach a neckstrap, cord, lanyard, or the like. There may be more than one hole 470 for attachment of a neckstrap or lanyard device. In some embodiments, the holder further comprises a neckstrap. Edge 455 may also include an indented portion 460 that may prevent occlusion of attachment loop 375 when the ridge 330 engages the trough 430.

In other embodiments, the holder 20 further comprises a pressure sensitive adhesive attached to the holder for adhesion of the holder 20 directly to a substrate such as clothing, fabrics, display panels, and the like.

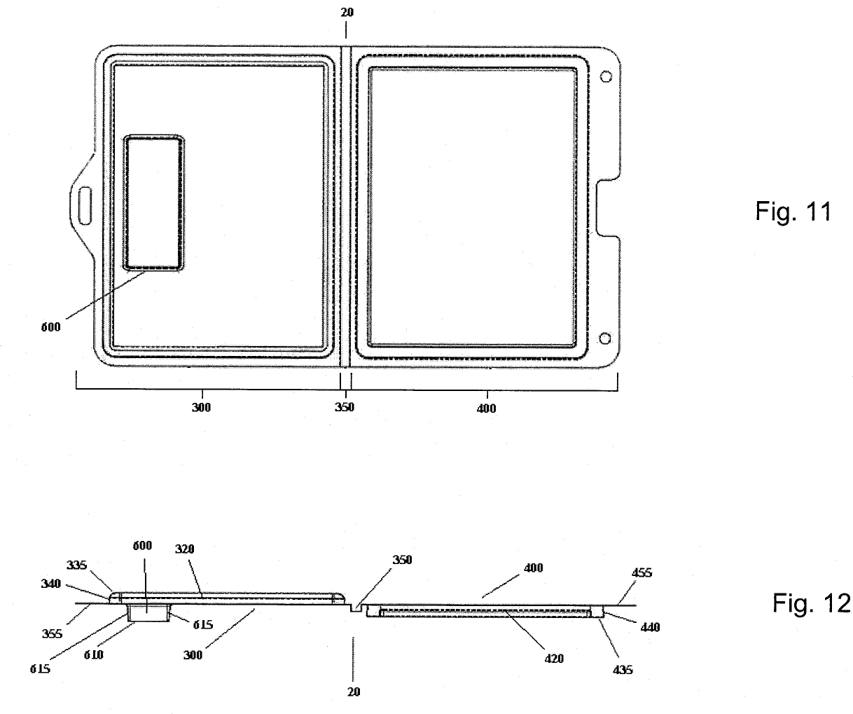

Referring now to FIGS. 11-13, in another aspect, the holder 20 further comprises a recessed button 600. The recessed button 600 comprises at least one side wall 615 and a floor 610. In some embodiments, the recessed button 600 holds a magnet, or magnetic material, as described above for recessed button 500 in holder 10.

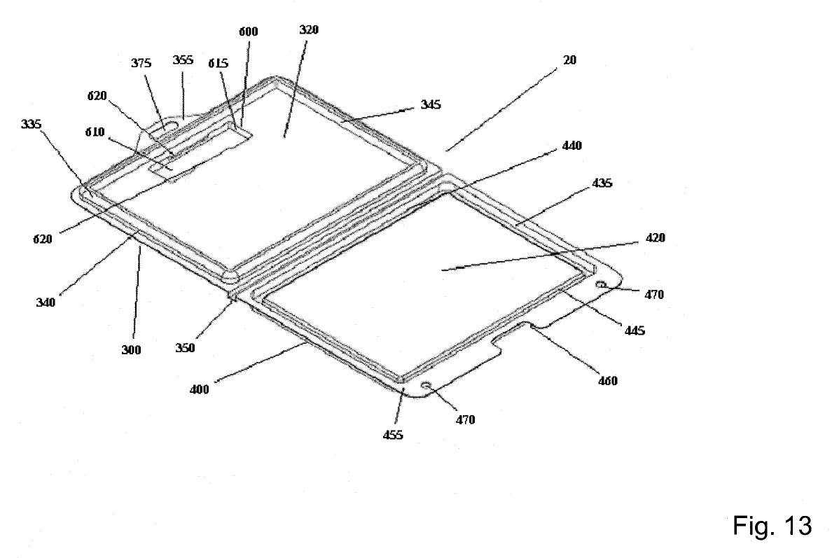

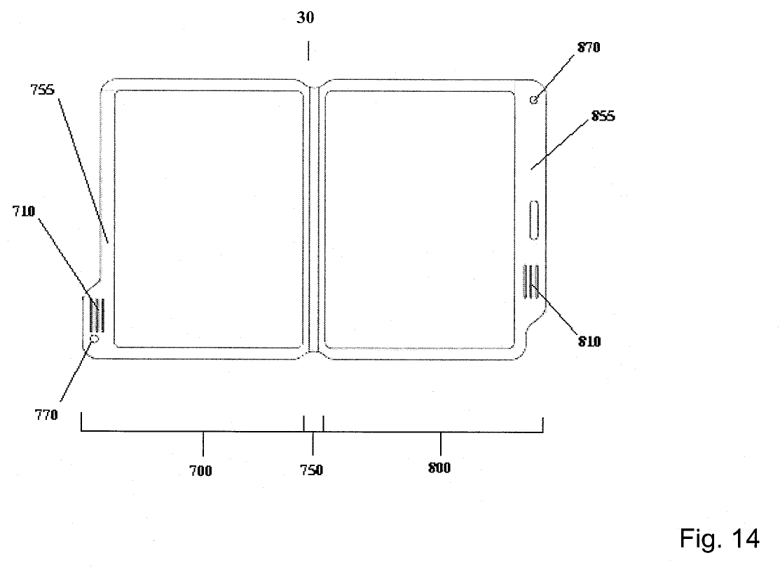

Referring specifically to FIG. 13, in some embodiments, the magnet, or magnetic material is held in the recessed button 600 by at least one locking edge 620, that extends over the recessed button 600 from the face 320. When the magnet, or magnetic material is inserted in the recessed button 600, the at least one locking edge 620 overlaps the magnet, or magnetic material to hold it in place in the recessed button 600. In some such embodiments, two or more locking edges 620 are provided. The at least one locking edge 620 allows for quick insertion of the magnet, or magnetic material, into the recessed button 600, and for easy removal. The at least one locking edge 620 also eliminates the need for separate adhesives for attaching the magnet to the holder 20, although as disclosed above, the magnet, or magnetic material may be adhered to the recessed button 600 of the holder 20 by an adhesive.

Thermoplastic materials useful for preparing the holders 10/20 may be selected from polymeric materials including, but not limited to, high and low density polyethylene, polypropylene, polyethylene terephthalate, silicones, polyvinyl chloride, or mixtures of two or more thereof.

In some embodiments, indicia containing materials, e.g. indicia containing material 50, are made of a material selected from paper, plastic, fabric or cardboard. In some embodiments, the indicia containing material is a nametag and/or badge. Indicia containing materials suitable for use with the holder 10/20 may further comprise recordation media selected from magnetic media, bar coded media, or a combination thereof. At tradeshows and the like, magnetic media are used to record information regarding attendees and vendors and can quickly and efficiently be exchanged through the use of magnetic readers. Bar coded information may also be used in a similar fashion with information exchanged using optical readers. Such magnetic media or bar codes may be associated with the indicia containing material as described above by methods known to those of skill in the art, including but not limited to adhesive attachment, printing, embossing, or other methods. Optionally, the magnetic media or bar codes may be attached to the holder 10/20 by methods known to those of skill in the art, including but not limited to adhesive attachment, printing, embossing, or other methods.

In another aspect, the holder 10/20 further comprises a fastener attached to the holder 10/20, as described above. In other embodiments, the holder 10/20 may further comprise an attachment loop. Such attachment loops may be integrated into the holder 10/20 such that a suitable fastener may be attached directly to the holder without the need for an adhesive. FIGS. 1 and 6 show one such embodiments of attachment loops 175/375. However, attachment loops are not so limited and may include integrally formed loops on a reverse face of the holder, the reverse face being a face that is parallel to and opposes the second face.

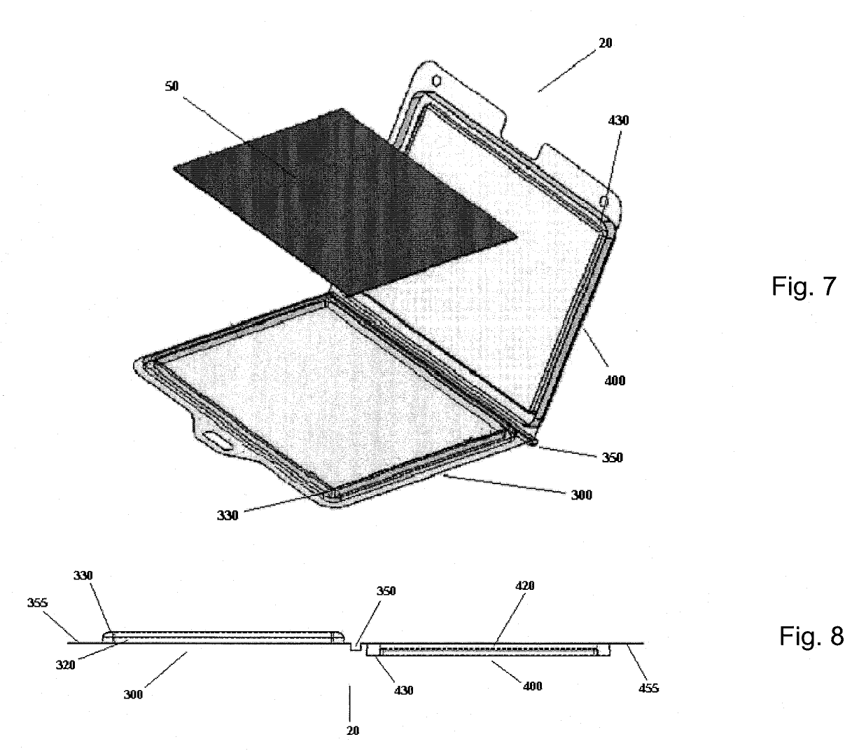

In another aspect, a holder 30, is provided as otherwise described above as holder 10/20. In some embodiments, holder 30 comprises a gripping area 710, as illustrated in FIG. 14, integrally formed in an edge 755 of a first flap 700 and/or a gripping area 810 integrally formed in an edge 855 of a second flap 800, the first flap 700 and second flap 800 being connected by a hinge 750. In such embodiments, the gripping area 710/810 may be used to open and close the holder 30. In some embodiments, the holder 30, comprises a hole 770, as illustrated in FIG. 14, integrally formed in the edge 755 of the first flap 700 and/or a hole 870 integrally formed in the edge 855 of the second flap 800. In such embodiments, the placement of the holes 770/870 allows a user to open the holder 10/20/30 when both the holes 770/870 are connected to a fastener, whether or not the holder 10/20/30 is being worn by a user, without removal of the fastener from the holder 10/20/30. The placement of holes 770/870 also allows a user to open the holder 10/20/30 to a clamshell configuration, as shown for example in FIG. 7, without the holder 10/20/30 opening to a fully open configuration as shown, for example, in FIGS. 1 and 14.

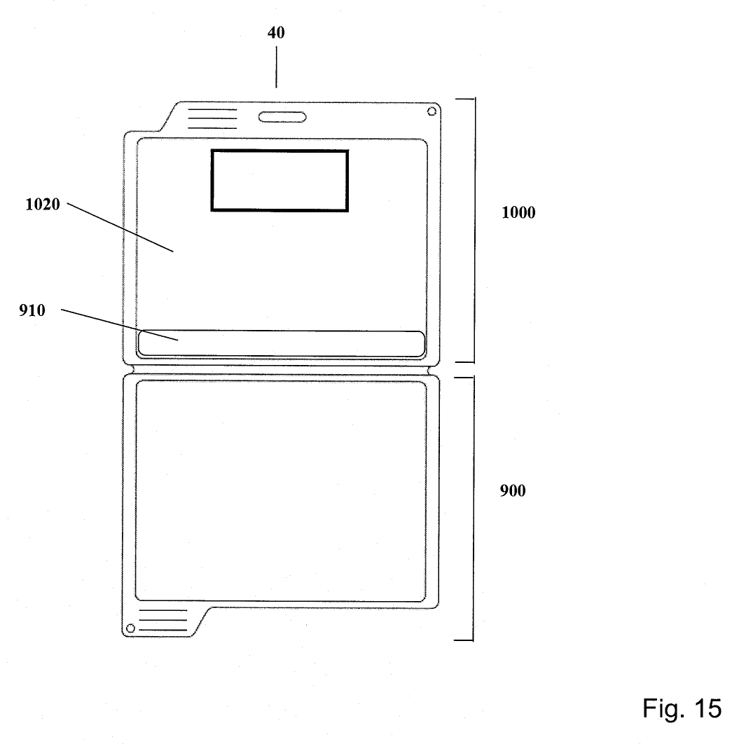

FIG. 15 is an open view of a holder 40 with a raised surface 910 on an external face 1020 of a second flap 1000 in accordance with an exemplary embodiment. In an exemplary embodiment, the external face 1020 can refer to the outer surface of second flap 1000 when the holder 40 is in a closed configuration. The raised surface 910 can be an external face of a formed recess in the second flap 1000. Alternatively, the raised surface 910 may be a strip of material mounted to the external face 1020 of the second flap 1000. In an alternative embodiment, the raised surface 910 may be placed on an external face of a first flap 900. Alternatively, raised surfaces may be placed on both external surface 1020 of second flap 1000 and the external surface of the first flap 900.

In an exemplary embodiment, the raised surface 910 may be used as a point or points of attachment for materials that may be attached and/or adhered to the holder. For example, designations may be provided on the holder identifying a wearer as an exhibitor, staff person, member, speaker, attendee, or other appropriate designation. There is no limit as to the designation chosen for a particular event. The designations may include color-coding or other identifying feature(s). The designations may be displayed as a vertical or horizontal ribbon that has an adhesive for application to the holder. In alternative embodiments, the raised surface 910 may not be included, and materials such as ribbons may be mounted directly to either the first flap 900 or the second flap 1000.

For the purposes of this disclosure and unless otherwise specified, “a” or “an” means “one or more.”

One skilled in the art will readily realize that all ranges discussed can and do necessarily also describe all subranges therein for all purposes, and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

While some embodiments have been illustrated and described, it should be understood that changes and modifications can be made therein in accordance with ordinary skill in the art without departing from the invention in its broader aspects as defined in the following claims.

What is claimed is:

1. A holder comprising:
a first flap, a second flap, and a hinge all integrally formed from a thermoplastic material; wherein
the first flap and the second flap are connected by the hinge;
the first flap comprising a raised portion comprising at least one side wall, and a first face;
the second flap comprising a recessed portion comprising at least one side wall, and a second face;
the raised portion adapted to engage the recessed portion;
such that when the raised portion engages the recessed portion, the first flap and the second flap are connected in a friction fit between the at least one side wall of the raised portion and the at least one side wall of the recessed portion.

2. The holder of claim 1, further comprising an indicia containing material capable of being secured between the first face and the second face.

3. The holder of claim 2, wherein the indicia containing material is a nametag.

4. The holder of claim 1, further comprising a fastener connected to the holder.

5. The holder of claim 4, wherein the fastener is connected to the holder by a pressure sensitive adhesive.

6. The holder of claim 1, further comprising a neckstrap connected to the holder.

7. The holder of claim 1, wherein the second flap further comprises an edge comprising at least one hole.

8. The holder of claim 1, further comprising a recessed button in the first flap or the second flap.

9. The holder of claim 8, wherein the recessed button comprises at least one locking edge.

10. The holder of claim 1, further comprising a raised surface on an external face of the first flap on the second flap, wherein the raised surface is a point of attachment for a display material.

11. A holder comprising:
a first flap, a second flap, and a hinge all integrally formed from a thermoplastic material; wherein
the first flap and the second flap are connected by the hinge;
the first flap comprising a surface and a ridge extending upwardly from the surface;
the ridge comprising at least one outer side wall, at least one inner side wall, and an apex;
the second flap comprising a surface and a trough extending downwardly from the surface;
the trough comprising at least one outer side wall, at least one inner side wall, and a nadir;
the ridge adapted to engage the trough, such that when the ridge engages the trough, the first flap and the second flap are connected in a friction fit between the at least one outer side wall of the ridge and the at least one outer side wall of the trough, or between the at least one inner side wall of the ridge and the at least one inner side wall of the trough, or between both the at least one outer side wall of the ridge and the at least one outer side wall of the trough, and the at least one inner side wall of the ridge and the at least one inner side wall of the trough.

12. The holder of claim 11, further comprising an indicia containing material capable of being secured between the surface of the first flap and the surface of the second flap.

13. The holder of claim 11, wherein the ridge forms a continuous frame around the perimeter of the first flap and the trough forms a continuous frame around the perimeter of the second flap.

14. The holder of claim 11, wherein the first flap comprises an edge extending outwardly from the outer side wall of the ridge and the second flap comprises an edge extending outwardly from the outer side wall of the trough.

15. The holder of claim 12, wherein the indicia containing material is a nametag.

16. The holder of claim 11, further comprising a fastener connected to the holder.

17. The holder of claim 16, wherein the fastener is connected to the holder by a pressure sensitive adhesive.

18. The holder of claim 11, further comprising a neckstrap connected to the holder.

19. The holder of claim 11, wherein the second flap further comprises an edge having at least one hole.

20. The holder of claim 11, further comprising a recessed button in the first flap or the second flap.

21. The holder of claim 20, wherein the recessed button comprises at least one locking edge.

22. The holder of claim 20, further comprising a magnetic fastener comprising at least one magnet and at least one magnetic material, wherein the at least one magnet is capable of being secured in the recessed button, such that the at least one magnet and the at least one magnetic material are capable of being used as a fastener for the holder.

23. The holder of claim 20, further comprising a magnetic fastener comprising at least one magnet and at least one magnetic material, wherein the at least one magnetic material is capable of being secured in the recessed button, such that the at least one magnet and the at least one magnetic material are capable of being used as a fastener for the holder.

24. The holder of claim 11, further comprising a raised surface on an external face of the first flap on the second flap, wherein the raised surface is a point of attachment for a display material.
